(19) United States
(12) Patent Application Publication
(10) Pub. No.: US 2006/0203102 A1
(43) Pub. Date: Sep. 14, 2006

(54) Method and apparatus for car equipped color compensation for color blindness

(76) Inventors: Seung-Ji Yang, Gangwon-Do (KR); Yong-Man Ro, Daejon-si (KR)

Correspondence Address: IPLA P.A., 3580 WILSHIRE BLVD., 17TH FLOOR, LOS ANGELES, CA, 90010, US

(21) Appl. No.: 10/565,364

(22) PCT Filed: Jul. 21, 2004
(86) PCT No.: PCT/KR04/01811

§ 371 Date: Jan. 20, 2006

(30) Foreign Application Priority Data
Jul. 21, 2003 (KR) 1020030049969

(51) Int. Cl. H04N 9/73

(52) U.S. Cl. 348/225.1

(57) ABSTRACT

The present invention relates to a method and apparatus for clearly detecting color information in front of a vehicle, and an object of the present invention is to accurately and efficiently show color-related traffic information, such as traffic lights and signs, and the whole color information of objects to color-blind people including people with dichromacy or anomalous trichromacy. The present invention provides a method of compensating for the colors of video frame data provided by a front camera, which includes the steps of compensating the video frame data, which is output from the camera, for external environment, such as surrounding colors and brightness, selecting a color range preferred by a user, compensating for the colors of the color-compensated video frame data according to the user's color blindness degree that was input or will be input, and transmitting external scenes, such as the front scene of the vehicle, to the user using a user interface considering user preference.

### TECHNICAL FIELD

The present invention relates generally to a method and apparatus for clearly detecting color information outside a vehicle and, more particularly, to an external observation camera for a vehicle, which compensates for the colors of video data based on the color contents of the video data input by the camera and according to the degree of the driver's color blindness, and surrounding brightness and chromaticity.

### BACKGROUND ART

Recently, with the development of semiconductor technology, inexpensive digital video cameras have appeared, and the video cameras are used as various types of observation cameras as Personal Computers (PCs) and the Internet have been popularized. From observation cameras in conventional buildings to web cameras in general homes, the use of observation cameras is increasing. In particular, digital cameras can store video frame data in a digital form, the image quality of the digital cameras is improved compared to that of conventional analog observation cameras, and the prices of disks, which are storage medium, are falling, thus accelerating the popularization of digital observation cameras.

Color blindness is a condition that occurs because cone cells in the retinas of eyes cannot perform the functions thereof. Most of color-blind people have difficulties in distinguishing or cannot distinguish the specific parts of the original color region visible to normal people. In the case where the color blindness is serious, there is the case where people cannot see colors at all.

About 8% or more of the population of the world is color-blind people. In particular, in the case of North America and Europe, the color blindness is so common a handicap that the population of color-blind people is more than about 10% of the total population. The color blindness is classified into complete color blindness and partial color blindness, and the partial color blindness is divided into dichromacy and anomalous trichromacy.

People with dichromacy do not have one of three cone cells (L, M and S cone cells). Accordingly, people with dichromacy sense all the colors of a visible wavelength region using only two chromaticities. According to the type of a cone cell that is absent, the dichromacy is divided into Protanopy in the case where an L cone cell is absent, Deuteranopy in the case where an M cone cell is absent, and Tritanopy in the case where an S cone cell is absent.

People with anomalous trichromacy have all three cone cells, but one of the three cone cells functions abnormally. The abnormal function of the cone cell occurs because the wavelength sensitivity of the cone cell moves or the amount of response to the sensitivity is reduced. Even though the cone cell is abnormal, three cone cells are present, so that the people with anomalous trichromacy can sense most colors in a visible wavelength region. The seriousness of the anomalous trichromacy is determined based on the degree of the movement of the wavelength sensitivity and the amount of the response, and the range of colors indistinguishable to the people with anomalous trichromacy becomes wider as the degree of the anomalous trichromacy is serious. Like the dichromacy, the anomalous trichromacy is also divided into Protanomaly, Deuteranomaly and Tritanomaly according to the type of the abnormal cone cell.

Most of color-blind people are people with Protanomaly/Deuteranomaly/Protanopy/Deuteranopy, and account for about 90% of all color-blind people. At present, a method of curing color blindness does not exist, and the Protanomaly, Deuteranomaly, Protanopy and Deuteranopy have hereditary characteristics in which the Protanomaly, Deuteranomaly, Protanopy and Deuteranopy are inherited by children from parents, so that a constant percentage of color-blind people exist.

In the case where the color-blind people drive, they have difficulties distinguishing colors due to the surrounding environment and color blindness characteristics. In particular, Red and Green-blind people (dichromacy/anomalous trichromacy) have considerable difficulties in distinguishing the colors of traffic lights. Red and Green-blind people are confused by the red, orange, yellow and green colors of the traffic lights. Since the current traffic lights system does not provide any means for distinguishing the colors of the traffic lights to the color-blind people, the development of a technology that can be practically applied is acutely required. Furthermore, there is the added inconvenience, in which the color-blind driver cannot distinguish the colors of other vehicles and buildings, so that the driver cannot receive various related pieces of information.

For a conventional technology that helps color-blind people to clearly distinguish colors, there is a method of wearing color glasses that filter out the colors of a specific wavelength region. When a color-blind person wears the color glasses and drives, the method enables the person to clearly distinguish colors. However, the method is problematic in that colors that are normally visible to the color-blind person can be differently sensed, and is disadvantageous in that it is difficult to consider various degrees of the seriousness of the anomalous trichromacy.

Furthermore, there is a technology that detects the locations of traffic lights through a satellite and servicing the colors of the traffic lights using characters. In this scheme, limitations in the detection of the accurate location of the traffic lights and operational accuracy in complicated areas, such as the central areas of towns, exist, and problems of costs and the complexity of the system occur. Furthermore, this scheme has a limitation in that it does not provide a measure in the case where the driver desires to detect the colors of preceding vehicles or surrounding buildings.

### DISCLOSURE OF THE INVENTION

Accordingly, the present invention has been made to solve the above problems, and an object of the present invention is to provide a method and apparatus that enables color-blind people, who are vehicle drivers, to sense the external colors of traffic lights and objects.

Furthermore, another object of the present invention is to provide a color compensation method and apparatus based on the color blindness degree of the color-blind people, external brightness, external colors and contents related to the colors of external objects.

In order to accomplish the above object, the present invention allows a digital video camera to be mounted on a vehicle, and converts surrounding visual information into digital video data. Accordingly, it is possible to display not only traffic lights but also visual information on surrounding environment to which a color-blind driver must pay attention while driving. Color compensation, which is depending on the color blindness characteristics of the color-blind driver, external environment (external brightness and external colors) and the characteristics of a display device, is performed based on the colors of video data contents by analyzing the colors of the obtained digital video data into digital signals.

According to an aspect of the present invention, a method of receiving video frame data from the external camera of a vehicle and compensating for colors for a color-blind person includes the steps of extracting R, G and B, which are color information, from the digital video frame data input by the external camera, measuring external brightness and colors from the video frame data, selecting a color range preferred by a user, compensating for colors by inputting the measured external brightness and colors, the color range preferred by the user and the driver's color blindness degree, and displaying the color information based on user preference according to the result of the color compensation.

Furthermore, according to another aspect of the present invention, the step of selecting the user preference in the color compensation method is performed in view of the selection of the color range to be displayed, the magnification of interested object and the audibly displaying of the color information.

Furthermore, according to another aspect of the present invention, the step of compensating colors for the color-blind driver in the color compensation method is performed using the external brightness, the external colors, the color range preferred by the user and the driver's color blind degree as variables.

Furthermore, according to another aspect of the present invention, an apparatus for receiving video frame data from an external camera of the vehicle and automatically compensating for colors for a person with anomalous trichromacy in a vehicle includes a means for measuring external brightness and colors from digital video frame data input from the external camera, a means for selecting a color range preferred by a user, a means for compensating for colors according to the input or measured driver's color blindness degree, external brightness, external colors and preferred color range, and a means for displaying the color information based on user preference according to the result of the color compensation.

Furthermore, according to another aspect of the present invention, an external observation camera system for receiving video frame data from the external camera of a vehicle further includes a color compensation apparatus for color-blind people, which includes a means for measuring external brightness and colors from the digital video frame data input from the external camera, a means for selecting a color range preferred by a user, a means for compensating for colors according to the input or measured driver's color blindness degree, the external brightness, the external colors and the preferred color range, and a means for displaying the color information based on user preference according to the result of the color compensation.

As described above, color-blind drivers can accurately detect colors using the color compensation method and apparatus of the present invention when the color-blind drivers desire to sense color-related traffic signals, such as traffic lights, and objects outside the vehicle. Furthermore, according to the present invention, the color-blind drivers can accurately sense colors in spite of their various color blindness degrees and various external environments, such as external brightness and colors.

### BRIEF DESCRIPTION OF THE DRAWINGS

FIG. 1 is a view showing an example in which a color compensation apparatus according to the present invention is mounted on a vehicle;

FIG. 2 is a block diagram showing the configuration of a system for the compensation for colors according to the present invention;

FIG. 3 is a block diagram of a video frame color compensation engine according to the present invention;

FIG. 4 is a flowchart illustrating a video frame color compensation process according to the present invention; and

FIG. 5 is a view showing an example of an observation image including a reference image piece.

### BEST MODE FOR CARRYING OUT THE INVENTION

An embodiment of the present invention is described in detail with reference to the attached drawings below. In the drawings, the same reference numerals are used throughout the different drawings to designate the same or similar components.

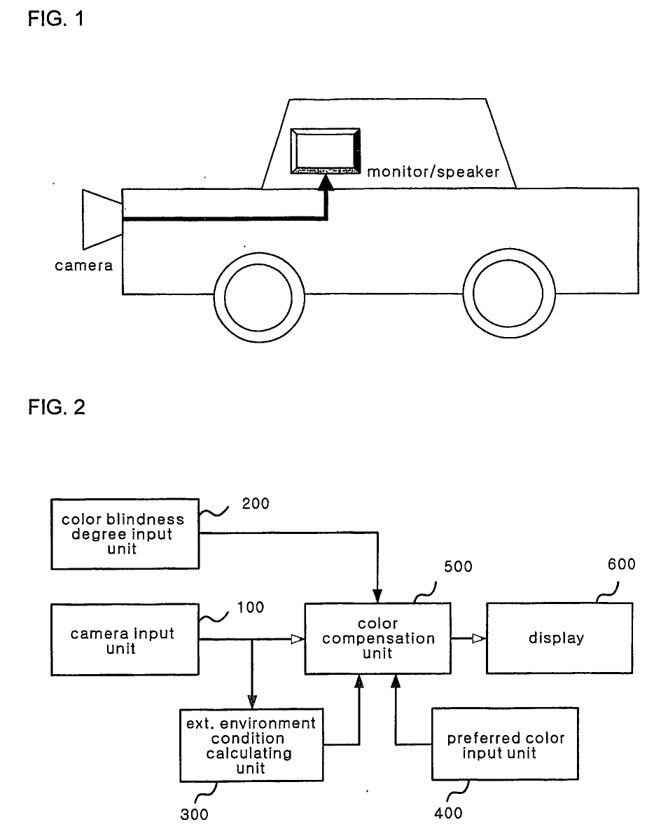

FIG. 1 is a view of an example in which an external color observation system for color-blind drivers according to the present invention is mounted on a vehicle, which shows a front screen observation system. FIG. 1 shows an example in which the final color information is represented to the color-blind drivers using a monitor or speaker.

FIG. 2 is a block diagram showing the construction of a system for the color compensation of an observation camera for a vehicle. In FIG. 2, a camera video frame input unit reads video frame data from a digital camera at step 100. At the same time, the camera video frame input unit receives the degree of the driver's color blindness at step 200. If there is no input, the degree of the driver's color blindness is replaced with the previously determined degree of color blindness. The video frame data is input to an external environment condition calculating unit at step 300, external brightness and colors are measured, and color compensation for the color-blind driver is performed in a color compensation unit according to a result of the measurement at step 500. In this case, the color compensation is performed in view of the range of preferred colors input by the driver. Finally, the color compensation based on magnification and the driver's preference is performed at step 400, and the video whose final color is compensated for is displayed on a screen at step 600.

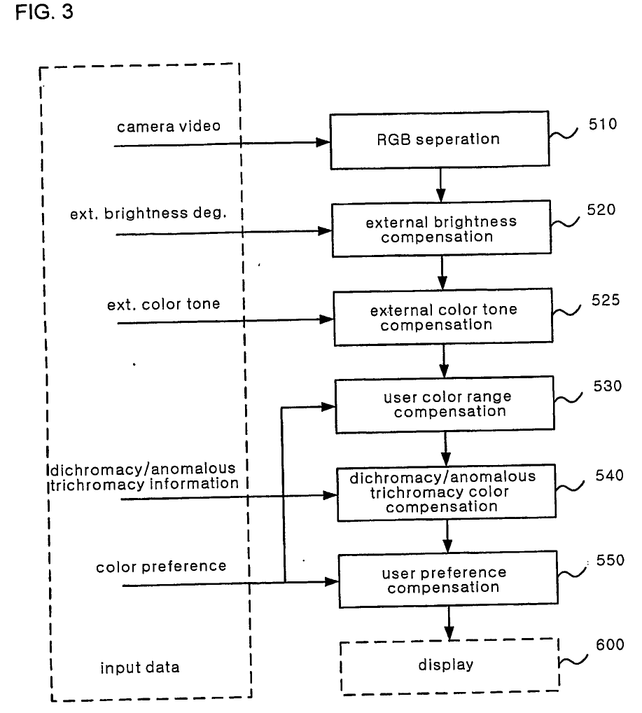

FIG. 3 is a block diagram showing a color compensation engine for color-blind drivers according to an embodiment of the present invention. Referring to FIG. 3, the color compensation engine is composed of six parts. First, Red (R), Green (G) and Blue (B) colors are extracted from the input video frame data at step 510, and external brightness information and an external color are extracted from the input video data at steps 520 and 525. In this case, the external brightness is calculated from R, G and B color signals that are separated from the reference image piece of the input video data, and the external color is obtained by calculating the average of R, G and B on the reference image piece. Thereafter, the color is compensated for to adjust it to a color range preferred by the driver at step 530. Thereafter, the color compensation for the color-blind driver is performed by inputting the external brightness and the external color extracted as described above, and the preferred color range and degree of the driver's color blindness at step 540. In this case, the driver's preference is considered when the color-compensated video is displayed at step 550 and color information is displayed at step 600.

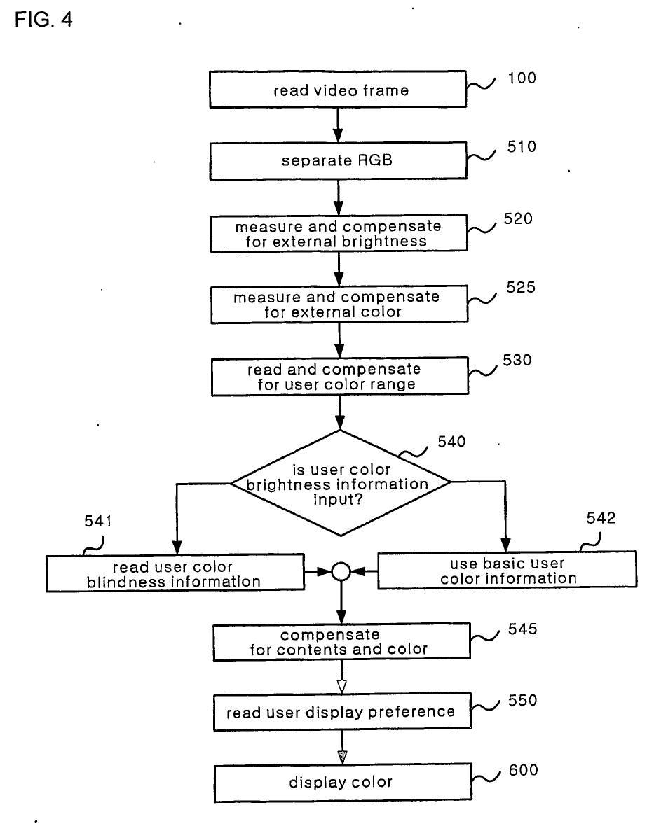

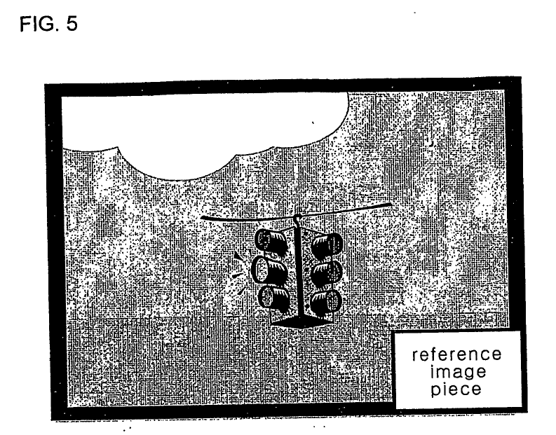

FIG. 4 is a flowchart illustrating a process of compensating for video frame colors according to an embodiment of the present invention. Referring to FIG. 4, video frame data is read by a digital camera at step 100. R, G and B colors are separated from the input data at step 510. As shown in FIG. 5, a reference image piece is placed on a side or lower portion of a video screen. The external brightness is calculated from the colors R, G and B on the image piece at step 520. The external brightness calculated as described above is expressed by Equation 1,

$$\begin{matrix}W {\vert}_{external brightness} = \frac{1}{\begin{matrix}number of pixels of \\ reference image piece\end{matrix}} \times \\ {\sum }_{( x , y ) ∈ reference image piece} \\ \{ \frac{R ( x , y ) + G ( x , y ) + B ( x , y )}{3} \}\end{matrix} \qquad ( 1 )$$

where W|_{external brightness} indicates external brightness specified on the image piece, and (x,y) indicates the location of a video pixel in a two-dimensional space. As shown in Equation 1, the external brightness is calculated by measuring the brightness on the reference image piece. Meanwhile, for consistent color compensation, reference external brightness W|_{reference brightness} is selected and all of the color compensations are performed with respect to the reference brightness. The external reference brightness can be calculated from the external reference color.

$$w {\vert}_{reference brightness} = \frac{\begin{matrix}R {\vert}_{reference color} + \\ G {\vert}_{reference color} + \\ B {\vert}_{reference color}\end{matrix}}{3} \qquad ( 2 )$$

The color compensation based on the external brightness W_{|external brightness} and the reference brightness W|_{reference brightness} is performed as described below at step 525. First, the brightness of the pixel of an input video is calculated using Equation 3,

$$W ( x , y ) = \frac{R ( x , y ) + G ( x , y ) + B ( x , y )}{3} \qquad ( 3 )$$

where (x,y) indicates the location of the pixel of an observation video frame.

Thereafter, R1, G1 and B1 signals whose brightness is compensated for are expressed in a homogeneous matrix as shown in Equation 4,

$$\begin{matrix}[ \begin{matrix}R 1 ( x , y ) \\ G 1 ( x , y ) \\ B 1 ( x , y ) \\ 1\end{matrix} ] = [ \begin{matrix}\frac{W {\vert}_{reference brightness}}{W ( x , y )} & 0 & 0 & 0 \\ 0 & \frac{W {\vert}_{reference brightness}}{W ( x , y )} & 0 & 0 \\ 0 & 0 & \frac{W {\vert}_{reference brightness}}{W ( x , y )} & 0 \\ 0 & 0 & 0 & 1\end{matrix} ] \times \\ [ \begin{matrix}R ( x , y ) \\ G ( x , y ) \\ B ( x , y ) \\ 1\end{matrix} ]\end{matrix} \qquad ( 4 )$$

Meanwhile, the external color is also calculated from the image piece at step 525. If it is assumed that the average value of the R, G and B colors of the image piece is the external color, the external color is expressed by Equation 5,

$$\begin{matrix}[ \begin{matrix}{R}_{externalcolor} \\ {G}_{externalcolor} \\ {B}_{externalcolor}\end{matrix} ] = \frac{1}{number of pixelsof referenceimage piece} \times \\ [ \begin{matrix}{\sum }_{( x , y ) ∈ referenceimage place} R ( x , y ) \\ {\sum }_{( x , y ) ∈ referenceimage place} G ( x , y ) \\ {\sum }_{( x , y ) ∈ referenceimage place} B ( x , y )\end{matrix} ]\end{matrix} \qquad ( 5 )$$

where R_{external color}, G_{external color} and B_{external color} indicate the R, G and B values of the external colors. For the reference, the brightness of the image piece is the W|_{external brightness} defined in Equation 1.

For consistent color compensation with respect to the external colors, color compensation is performed to achieve the reference color shown in Equation 2. For color compensation according to the reference color, the difference values between the external colors and the reference colors are compared, and R, G and B difference values in pixels are calculated, so that Equation 6 is obtained.

$$Δ R ( x , y ) = \frac{W ( x , y )}{W {\vert}_{external brightness}} ( R {\vert}_{external color} - R {\vert}_{reference color} ) \\ Δ G ( x , y ) = \frac{W ( x , y )}{W {\vert}_{external brightness}} ( G {\vert}_{external color} - G {\vert}_{reference color} ) \\ Δ B ( x , y ) = \frac{W ( x , y )}{W {\vert}_{external brightness}} ( B {\vert}_{external color} - B {\vert}_{reference color} ) \qquad ( 6 )$$

Thereafter, R2, G2 and B2 signals whose external colors have been compensated for are expressed in a homogeneous matrix as shown in Equation 7,

$$[ \begin{matrix}R 2 ( x , y ) \\ G 2 ( x , y ) \\ B 2 ( x , y ) \\ 1\end{matrix} ] = [ \begin{matrix}1 & 0 & 0 & Δ R ( x , y ) \\ 0 & 1 & 0 & Δ G ( x , y ) \\ 0 & 0 & 1 & Δ B ( x , y ) \\ 0 & 0 & 0 & 1\end{matrix} ] \times [ \begin{matrix}R 1 ( x , y ) \\ G 1 ( x , y ) \\ B 1 ( x , y ) \\ 1\end{matrix} ] \qquad ( 7 )$$

Thereafter, the ranges of colors, which are set by a user, are selected and colors, which are used depending on the selection, are quantized as expressed by Equation 8 at step 530,

$$\begin{matrix}[ \begin{matrix}R 3 ( x , y ) \\ G 3 ( x , y ) \\ B 3 ( x , y ) \\ 1\end{matrix} ] = round [ \begin{matrix}\frac{1}{Qstep\_R} & 0 & 0 & 0 \\ 0 & \frac{1}{Qstep\_R} & 0 & 0 \\ 0 & 0 & \frac{1}{Qstep\_R} & 0 \\ 0 & 0 & 0 & 1\end{matrix} ] \times \\ [ \begin{matrix}R 2 ( x , y ) \\ G 2 ( x , y ) \\ B 2 ( x , y ) \\ 1\end{matrix} ]\end{matrix} \qquad ( 8 )$$

where

$$\frac{1}{Qstep\_R} , \frac{1}{Qstep\_G} , and \frac{1}{Qstep\_B}$$

indicate quantization steps for R, G and B, respectively, and round( ) indicates a function for forming an integer. The ranges of colors finally used are determined by controlling the quantization steps for the colors. If the narrow ranges of the colors are used, different colors are clearly distinguished (color contour) from each other, thus helping color-blind people to distinguish the different colors. The color discrimination depending on the color blindness can be improved through the color contour through the process of controlling the ranges of colors.

Subsequently, driver's color blindness characteristic information is input at step 540. If the driver inputs new color blindness information at step 541, that information is used. If there is no input at step 542, the driver's previously used color blindness information is used.

The color blindness characteristic information is shown by Table 1. Numerical values, which indicate the degree of anomalous trichromacy for colors are defined as d_{R}, d_{G} and d_{B} with relation to Protanomaly/Protanopy, Deuteranomaly/Deuteranopy and Tritanomaly/Tritanopy, respectively.

TABLE 1

Color blindness features

| | | Numerical expression |
|---|---|---|
| | Type of color | of degree of color |
| Medical term | blindness | blindness (d) |
| Protanomaly | Red-Deficiency | 0.1 to 0.9 |
| Protanopy | Red-Deficiency | 1.0 |
| Deuteranomaly | Green-Deficiency | 0.1 to 0.9 |
| Deuteranopy | Green-Deficiency | 1.0 |
| Tritanomaly | Blue-Deficiency | 0.1 to 0.9 |
| Tritanopy | Blue-Deficiency | 1.0 |

The final color sense characteristics of the color-blind driver respond in combination with not only the color blindness characteristics but also the display device characteristics of the driver. The sense of the wavelengths of the colors of humans is performed by three types of cone cells, and the characteristics of the colors can be shown in L, M and S spaces. If the colors are sensed from a display device such as a monitor, the R, G and B characteristics of the monitor must be considered. The amount of colors, which can be sensed by the L, M and S cone cells of humans, with respect to the characteristics of the wavelength of the display device is expressed by Equation 9,
L_{R}=∫kₗL(λ)R(λ)dλ
L_{G}=∫kₗL(λ)G(λ)dλ
L_{B}=∫kₗL(λ)B(λ)dλ
M_{R}=∫kₘM(λ)R(λ)dλ
M_{G}=∫kₘM(λ)G(λ)dλ
M_{B}=∫kₘM(λ)B(λ)dλ
S_{R}=∫kₛS(λ)R(λ)dλ
S_{G}=∫kₛS(λ)G(λ)dλ
S_{B}=∫kₛS(λ)B(λ)dλ (9)

In this case, if the characteristics of a color-blind person other than a normal person are input at steps 541 and 542, the cone cells of the color-blind person respond differently from that of the normal person. If the color-blind person has Protanomaly and the degree of the Protanomaly is d_{R}, the responses of the cone cells can be expressed using p(d_{R}) and q(d_{R}) functions. Equation 10 expresses the case of Red blindness and the abnormality of L cone cell. Meanwhile, the M and S cone cells are normal like in Equation 9,
L_{R}^{color blindness}=∫=p(d_{R})L(λ−q(d_{R}))R(λ)dλ
L_{G}^{color blindness}=∫=p(d_{R})L(λ−q(d_{R}))G(λ)dλ
L_{B}^{color blindness}=∫=p(d_{R})L(λ−q(d_{B}))B(λ)dλ (10)
where p(d_{R}) indicates the amount of the abnormal response of the L cone cell, and q(d_{R}) indicates the abnormal response to the wavelength of the L cone cell.

Subsequently, in the case of Green blindness and the degree of thereof is d_{G}, the response of the M cone cell is changed as expressed by Equation 11. The L and S cone cells are normal like in Equation 9,
M_{R}^{color blindness}=∫=p(d_{G})M(λ−q(d_{G}))R(λ)dλ
M_{G}^{color blindness}=∫=p(d_{G})M(λ−q(d_{G}))G(λ)dλ
M_{B}^{color blindness}=∫=p(d_{G})M(λ−q(d_{G}))G(λ)dλ (11)
where p(d_{G}) indicates the amount of the abnormal response of the M cone cell, and q(d_{G}) indicates the abnormal response to the wavelength of the M cone cell.

Subsequently, in the case of Blue blindness and the degree of thereof is d_{B}, the response of the S cone cell is changed as expressed by Equation 12. The L and M cone cells are normal like in Equation 9,
S_{R}^{color blindness}=∫=p(d_{B})S(λ−q(d_{B}))R(λ)dλ
S _{G}^{color blindness}=∫=p(d_{B})S(λ−q(d_{B}))G(λ)dλ
S_{B}^{color blindness}=∫=p(d_{B})S(λ−q(d_{B}))B(λ)dλ (12)
where p(d_{B}) indicates the amount of the abnormal response of the S cone cell, and q(d_{B}) indicates the abnormal response to the wavelength of the M cone cell.

In view of Equations 10 to 12, a process of compensating for indistinguishable colors is described below. First, color compensation for Red blindness, whose degree is d_{R}, is performed using Equation 13,

$$\begin{matrix}[ \begin{matrix}R 4 ( x , y ) \\ G 4 ( x , y ) \\ B 4 ( x , y ) \\ 1\end{matrix} ] = {[ \begin{matrix}{L}_{R}^{{color}_{blindness}} & {L}_{G}^{{color}_{blindness}} & {L}_{B}^{{color}_{blindness}} & 0 \\ {M}_{R} & {M}_{G} & {M}_{B} & 0 \\ {S}_{R} & {S}_{G} & {S}_{B} & 0 \\ 0 & 0 & 0 & 1\end{matrix} ]}^{- 1} \times \\ [ \begin{matrix}{L}_{R} & {L}_{G} & {L}_{B} & 0 \\ {M}_{R} & {M}_{G} & {M}_{B} & 0 \\ {S}_{R} & {S}_{G} & {S}_{B} & 0 \\ 0 & 0 & 0 & 1\end{matrix} ] \times [ \begin{matrix}R 3 ( x , y ) \\ G 3 ( x , y ) \\ B 3 ( x , y ) \\ 1\end{matrix} ]\end{matrix} \qquad ( 13 )$$

where the first LMS response matrix indicates compensation for color blindness, and the second matrix is a matrix for changing a color space from RGB to LMS.

Subsequently, color compensation for Green blindness, whose degree is d_{G}, is performed using Equation 14,

$$[ \begin{matrix}R 4 ( x , y ) \\ G 4 ( x , y ) \\ B 4 ( x , y ) \\ 1\end{matrix} ] = {[ \begin{matrix}{L}_{R} & {L}_{G} & {L}_{B} & 0 \\ {M}_{R}^{color blindness} & {M}_{G}^{color blindness} & {M}_{B}^{color blindness} & 0 \\ {S}_{R} & {S}_{G} & {S}_{B} & 0 \\ 0 & 0 & 0 & 1\end{matrix} ]}^{- 1} \times [ \begin{matrix}{L}_{R} & {L}_{G} & {L}_{B} & 0 \\ {M}_{R} & {M}_{G} & {M}_{B} & 0 \\ {S}_{R} & {S}_{G} & {S}_{B} & 0 \\ 0 & 0 & 0 & 0\end{matrix} ] \times [ \begin{matrix}R 3 ( x , y ) \\ G 3 ( x , y ) \\ B 3 ( x , y ) \\ 1\end{matrix} ] \qquad ( 14 )$$

Thereafter, color compensation for Blue blindness, whose degree is d_{B}, is performed using Equation 15,

$$[ \begin{matrix}R 4 ( x , y ) \\ G 4 ( x , y ) \\ B 4 ( x , y ) \\ 1\end{matrix} ] = {[ \begin{matrix}{L}_{R} & {L}_{G} & {L}_{B} & 0 \\ {M}_{R} & {M}_{G} & {M}_{B} & 0 \\ {S}_{R}^{color blindness} & {S}_{G}^{color blindness} & {S}_{B}^{color blindness} & 0 \\ 0 & 0 & 0 & 1\end{matrix} ]}^{- 1} \times [ \begin{matrix}{L}_{R} & {L}_{G} & {L}_{B} & 0 \\ {M}_{R} & {M}_{G} & {M}_{B} & 0 \\ {S}_{R} & {S}_{G} & {S}_{B} & 0 \\ 0 & 0 & 0 & 0\end{matrix} ] \times [ \begin{matrix}R 3 ( x , y ) \\ G 3 ( x , y ) \\ B 3 ( x , y ) \\ 1\end{matrix} ] \qquad ( 15 )$$

Final color compensation in view of external brightness, external colors, a user selected color range, and driver's color blindness information is expressed by Equation 16 at step 545,

$$[ \begin{matrix}R 4 ( x , y ) \\ G 4 ( x , y ) \\ B 4 ( x , y ) \\ 1\end{matrix} ] = {[ \begin{matrix}{L}_{R}^{color blindness} & {L}_{G}^{color blindness} & {L}_{B}^{color blindness} & 0 \\ {M}_{R} & {M}_{G} & {M}_{B} & 0 \\ {S}_{R} & {S}_{G} & {S}_{B} & 0 \\ 0 & 0 & 0 & 1\end{matrix} ]}^{- 1} \times [ \begin{matrix}{L}_{R} & {L}_{G} & {L}_{B} & 0 \\ {M}_{R} & {M}_{G} & {M}_{B} & 0 \\ {S}_{R} & {S}_{G} & {S}_{B} & 0 \\ 0 & 0 & 0 & 1\end{matrix} ] \times round \{ [ \begin{matrix}\frac{1}{Qstep\_R} & 0 & 0 & 0 \\ 0 & \frac{1}{Qstep\_G} & 0 & 0 \\ 0 & 0 & \frac{1}{Qstep\_B} & 0 \\ 0 & 0 & 0 & 1\end{matrix} ] \times [ \begin{matrix}1 & 0 & 0 & Δ R ( x , y ) \\ 0 & 1 & 0 & Δ G ( x , y ) \\ 0 & 0 & 1 & Δ B ( x , y ) \\ 0 & 0 & 0 & 1\end{matrix} ] \times \\ [ \begin{matrix}\frac{W {\vert}_{{reference}_{brightness} }}{W ( x , y )} & 0 & 0 & 0 \\ 0 & \frac{W {\vert}_{{reference}_{brightness} }}{W ( x , y )} & 0 & 0 \\ 0 & 0 & \frac{W {\vert}_{{reference}_{brightness} }}{W ( x , y )} & 0 \\ 0 & 0 & 0 & 1\end{matrix} ] \times [ \begin{matrix}R ( x , y ) \\ G ( x , y ) \\ B ( x , y ) \\ 1\end{matrix} ] \} \qquad ( 16 )$$

where R(x,y), G(x,y) and B(x,y) indicate color signals input by an external camera, and R4(x,y) , G4(x,y) and B4(x,y) indicate the final color values obtained by compensation for the color blindness of the driver. Equation 16 expresses compensation for Red blindness, and Equations 17 and 18 express compensation for Green blindness and Blue blindness, respectively.

$$[ \begin{matrix}R 4 ( x , y ) \\ G 4 ( x , y ) \\ B 4 ( x , y ) \\ 1\end{matrix} ] = {[ \begin{matrix}{L}_{R} & {L}_{G} & {L}_{B} & 0 \\ {M}_{R}^{color blindness} & {M}_{G}^{color blindness} & {M}_{B}^{color blindness} & 0 \\ {S}_{R} & {S}_{g} & {S}_{b} & 0 \\ 0 & 0 & 0 & 1\end{matrix} ]}^{- 1} \times [ \begin{matrix}{L}_{R} & {L}_{G} & {L}_{B} & 0 \\ {M}_{R} & {M}_{g} & {M}_{B} & 0 \\ {S}_{R} & {S}_{G} & {S}_{b} & 0 \\ 0 & 0 & 0 & 1\end{matrix} ] \times round \{ [ \begin{matrix}\frac{1}{Qstep\_R} & 0 & 0 & 0 \\ 0 & \frac{1}{Qstep\_G} & 0 & 0 \\ 0 & 0 & \frac{1}{Qstep\_B} & 0 \\ 0 & 0 & 0 & 1\end{matrix} ] \times [ \begin{matrix}1 & 0 & 0 & Δ R ( x , y ) \\ 0 & 1 & 0 & Δ G ( x , y ) \\ 0 & 0 & 1 & Δ B ( x , y ) \\ 0 & 0 & 0 & 1\end{matrix} ] \times [ \begin{matrix}\frac{W {\vert}_{reference \\ brightness}}{W ( x , y )} & 0 & 0 & 0 \\ 0 & \frac{W {\vert}_{reference \\ brightness}}{W ( x , y )} & 0 & 0 \\ 0 & 0 & \frac{W {\vert}_{reference \\ brightness}}{W ( x , y )} & 0 \\ 0 & 0 & 0 & 1\end{matrix} ] \times [ \begin{matrix}R ( x , y ) \\ G ( x , y ) \\ B ( x , y ) \\ 1\end{matrix} ] \} \qquad ( 17 )$$

$$[ \begin{matrix}R 4 ( x , y ) \\ G 4 ( x , y ) \\ B 4 ( x , y ) \\ 0\end{matrix} ] = {[ \begin{matrix}{L}_{R} & {L}_{G} & {L}_{B} & 0 \\ {M}_{R} & {M}_{G} & {M}_{B} & 0 \\ {S}_{R}^{color blindness} & {S}_{G}^{color blindness} & {M}_{B}^{color blindness} & 0 \\ 0 & 0 & 0 & 1\end{matrix} ]}^{- 1} \times [ \begin{matrix}{L}_{R} & {L}_{G} & {L}_{B} & 0 \\ {M}_{R} & {M}_{G} & {M}_{B} & 0 \\ {S}_{R} & {S}_{G} & {S}_{B} & 0 \\ 0 & 0 & 0 & 1\end{matrix} ] \times round \{ [ \begin{matrix}\frac{1}{Qstep\_R} & 0 & 0 & 0 \\ 0 & \frac{1}{Qstep\_G} & 0 & 0 \\ 0 & 0 & \frac{1}{Qstep\_B} & 0 \\ 0 & 0 & 0 & 1\end{matrix} ] \times [ \begin{matrix}1 & 0 & 0 & Δ R ( x , y ) \\ 0 & 1 & 0 & Δ G ( x , y ) \\ 0 & 0 & 1 & Δ B ( x , y ) \\ 0 & 0 & 0 & 1\end{matrix} ] \times [ \begin{matrix}\frac{W {\vert}_{reference \\ brightness}}{W ( x , y )} & 0 & 0 & 0 \\ 0 & \frac{W {\vert}_{reference \\ brightness}}{W ( x , y )} & 0 & 0 \\ 0 & 0 & \frac{W {\vert}_{reference \\ brightness}}{W ( x , y )} & 0 \\ 0 & 0 & 0 & 1\end{matrix} ] \times [ \begin{matrix}R ( x , y ) \\ G ( x , y ) \\ B ( x , y ) \\ 1\end{matrix} ] \} \qquad ( 18 )$$

In Equations 16 to 18, since the case of dichromacy corresponds to the case where the L, M and S cone cells are absent, corresponding values are zero. For this compensation, the L, M and S are set to small specific constant values other than zero, and the Equations are calculated.

Before the video, on which compensation for color blindness was performed as described above, is displayed, the preference of the driver related to display is considered at step 550. In particular, when the driver desires to sense the color of traffic lights or a specific preceding vehicle, a specific object magnification function of magnifying the traffic lights or preceding vehicle, and voice service for the selected color are included. The specific object magnification function is performed in such a way that a driver selects an object and the object is magnified in a software zoom manner or in a hardware zoom manner at step 600.

Furthermore, the voice service for colors is a service using a text-To-Speech (TTS) technology, and performed in such a way that the color of an object indicated by the driver is obtained from a frame screen, and the color is changed to characters using the TTS technology at step 600.

The above-described embodiment is set forth to enable those skilled in the art to easily understand the present invention, but is not set forth to limit the scope of the present invention. Accordingly, those skilled in the art must appreciate the possibilities of various modifications and alternations without departing from the scope of the present invention. In principle, the scope of the present invention is determined by claims that will be described later.

### INDUSTRIAL APPLICABILITY

As described above, according to the present invention, a color-blind driver can accurately sense colors by the color compensation method and device of the present invention when the driver senses the colors of traffic signals, such as traffic lights, and objects outside a vehicle. Furthermore, according to the present invention, the driver can accurately determine the colors of external environments, such as various color blindness degrees, external brightness and color tone.

1. A color compensation method of receiving video frame data from a camera outside a vehicle and automatically compensating for colors of the video frame data for a person with anomalous trichromacy in the vehicle, comprising the steps of:
extracting digital video frame data from a digital observation camera;
calculating external environment conditions from the extracted video frame data;
receiving color blindness characteristics of a color-blind driver;
receiving preference of the color-blind driver;
compensating for colors of the video frame data according to the external environment conditions and the input information; and
displaying finally compensated colors according to the preference of the color-blind driver.

2. The method according to claim 1, wherein the step of calculating the external environment conditions is performed in such a way that brightness and colors of external environment are extracted from the video frame data and transmitted to a color compensation unit.

3. The method according to claim 1, wherein the step of receiving the color blindness characteristics is performed in such a way as to receive a type and degree of the color blindness and display the type of the color blindness, and degrees of abnormality of cone cells related to colors are expressed using functions p and q as follows:
in the case of Red blindness,
L_{R}^{color blindness}=∫=p(d_{R})L(λ−q(d_{R}))R(λ)dλ
L_{G}^{color blindness}=∫=p(d_{R})L(λ−q(d_{R}))G(λ)dλ
L_{B}^{color blindness}=∫=p(d_{R})L(λ−q(d_{R}))B(λ)dλ
in the case of Green blindness,
M_{R}^{color blindness}=∫=p(d_{G})M(λ−q(d_{G}))R(λ)dλ
M_{G}^{color blindness}=∫=p(d_{G})M(λ−q(d_{G}))G(λ)dλ
M_{B}^{color blindness}=∫=p(d_{G})M(λ−q(d_{G}))B(λ)dλ
in the case of Blue blindness,
S_{R}^{color blindness}=∫=p(d_{B})S(λ−q(d_{B}))R(λ)dλ
S_{G}^{color blindness}=∫=p(d_{B})S(λ−q(d_{B}))G(λ)dλ
S_{B}^{color blindness}=∫=p(d_{B})S(λ−q(d_{B}))B(λ)dλ

4. The method according to claim 1, wherein the step of receiving the preference of the driver comprises the steps of:
quantizing a range of colors preferred by the color-blind driver and setting the range to enable the driver to clearly distinguish different colors;
magnifying a part of an object desired to be shown in detail by the driver when the driver desires to sense colors of traffic lights or external environment; and
reading the colors of the corresponding object, changing the colors to characters, and representing the characters in a voice form using a Text-To-Speech (TTS) technology.

5. The method according to claim 2, wherein the extraction of the brightness and the colors of the external environment is performed in such a way that a portion of the video frame screen is set to a reference image piece and the external brightness and colors are measured from the reference image.

6. The method according to claim 5, wherein the step of compensating for colors using the reference image piece is performed in such a way that a color tone is calibrated using a difference between reference brightness and colors that are previously measured from the reference image piece and stored in a daylight condition, and the external brightness and colors calculated at the step of calculating the external environment.

7. The method according to claim 1, wherein:
the step of compensating f or colors of the video frame data comprises all the steps of compensating for colors depending on the input external environment conditions, compensating for colors that is performed by compensating RGB colors of the extracted video frame data according to a color range of user preference, and compensating for colors depending on the input color blindness characteristics of the driver; and
wherein, in the case of dichromacy, the step of compensating for colors is applied, with a small specific constant numbers other than zero being set instead of an L, M or S value;
wherein the step of compensating for colors is performed using one of the following equations,
in the case of Red blindness,
$$[ \begin{matrix}R 4 ( x , y ) \\ G 4 ( x , y ) \\ B 4 ( x , y ) \\ 1\end{matrix} ] = {[ \begin{matrix}{L}_{R}^{color blindness} & {L}_{G}^{color blindness} & {L}_{B}^{color blindness} & 0 \\ {M}_{R} & {M}_{G} & {M}_{B} & 0 \\ {S}_{R} & {S}_{G} & {S}_{B} & 0 \\ 0 & 0 & 0 & 1\end{matrix} ]}^{- 1} \times [ \begin{matrix}{L}_{R} & {L}_{G} & {L}_{B} & 0 \\ {M}_{R} & {M}_{G} & {M}_{B} & 0 \\ {S}_{R} & {S}_{G} & {S}_{B} & 0 \\ 0 & 0 & 0 & 1\end{matrix} ] \times round \{ [ \begin{matrix}\frac{1}{Qstep\_R} & 0 & 0 & 0 \\ 0 & \frac{1}{Qstep\_G} & 0 & 0 \\ 0 & 0 & \frac{1}{Qstep\_B} & 0 \\ 0 & 0 & 0 & 1\end{matrix} ] \times [ \begin{matrix}1 & 0 & 0 & Δ R ( x , y ) \\ 0 & 1 & 0 & Δ G ( x , y ) \\ 0 & 0 & 1 & Δ B ( x , y ) \\ 0 & 0 & 0 & 1\end{matrix} ] \times \\ [ \begin{matrix}\frac{W {\vert}_{{reference}_{bright} }}{W ( x , y )} & 0 & 0 & 0 \\ 0 & \frac{W {\vert}_{{reference}_{bright} }}{W ( x , y )} & 0 & 0 \\ 0 & 0 & \frac{W {\vert}_{{reference}_{bright} }}{W ( x , y )} & 0 \\ 0 & 0 & 0 & 1\end{matrix} ] \times [ \begin{matrix}R ( x , y ) \\ G ( x , y ) \\ B ( x , y ) \\ 1\end{matrix} ] \}$$
in the case of Green blindness,
$$[ \begin{matrix}R 4 ( x , y ) \\ G 4 ( x , y ) \\ B 4 ( x , y ) \\ 1\end{matrix} ] = {[ \begin{matrix}{L}_{R} & {L}_{G} & {L}_{B} & 0 \\ {M}_{R}^{color blindness} & {M}_{G}^{color blindness} & {M}_{B}^{color blindness} & 0 \\ {S}_{R} & {S}_{G} & {S}_{B} & 0 \\ 0 & 0 & 0 & 1\end{matrix} ]}^{- 1} \times [ \begin{matrix}{L}_{R} & {L}_{G} & {L}_{B} & 0 \\ {M}_{R} & {M}_{G} & {M}_{B} & 0 \\ {S}_{R} & {S}_{G} & {S}_{B} & 0 \\ 0 & 0 & 0 & 1\end{matrix} ] \times round \{ [ \begin{matrix}\frac{1}{Qstep\_R} & 0 & 0 & 0 \\ 0 & \frac{1}{Qstep\_G} & 0 & 0 \\ 0 & 0 & \frac{1}{Qstep\_B} & 0 \\ 0 & 0 & 0 & 1\end{matrix} ] \times [ \begin{matrix}1 & 0 & 0 & Δ R ( x , y ) \\ 0 & 1 & 0 & Δ G ( x , y ) \\ 0 & 0 & 1 & Δ B ( x , y ) \\ 0 & 0 & 0 & 1\end{matrix} ] \times \\ [ \begin{matrix}\frac{W {\vert}_{{reference}_{brightness} }}{W ( x , y )} & 0 & 0 & 0 \\ 0 & \frac{W {\vert}_{{reference}_{brightness} }}{W ( x , y )} & 0 & 0 \\ 0 & 0 & \frac{W {\vert}_{{reference}_{brightness} }}{W ( x , y )} & 0 \\ 0 & 0 & 0 & 1\end{matrix} ] \times [ \begin{matrix}R ( x , y ) \\ G ( x , y ) \\ B ( x , y ) \\ 1\end{matrix} ] \}$$
in the case of Blue blindness,
$$[ \begin{matrix}R 4 ( x , y ) \\ G 4 ( x , y ) \\ B 4 ( x , y ) \\ 1\end{matrix} ] = {[ \begin{matrix}{L}_{R} & {L}_{G} & {L}_{B} & 0 \\ {M}_{R} & {M}_{G} & {M}_{B} & 0 \\ {S}_{R}^{color blindness} & {S}_{G}^{color blindness} & {S}_{B}^{color blindness} & 0 \\ 0 & 0 & 0 & 1\end{matrix} ]}^{- 1} \times [ \begin{matrix}{L}_{R} & {L}_{G} & {L}_{B} & 0 \\ {M}_{R} & {M}_{G} & {M}_{B} & 0 \\ {S}_{R} & {S}_{G} & {S}_{B} & 0 \\ 0 & 0 & 0 & 1\end{matrix} ] \times round \{ [ \begin{matrix}\frac{1}{Qstep\_R} & 0 & 0 & 0 \\ 0 & \frac{1}{Qstep\_G} & 0 & 0 \\ 0 & 0 & \frac{1}{Qstep\_B} & 0 \\ 0 & 0 & 0 & 1\end{matrix} ] \times [ \begin{matrix}1 & 0 & 0 & Δ R ( x , y ) \\ 0 & 1 & 0 & Δ G ( x , y ) \\ 0 & 0 & 1 & Δ B ( x , y ) \\ 0 & 0 & 0 & 1\end{matrix} ] \times \\ [ \begin{matrix}\frac{W {\vert}_{{reference}_{brightness} }}{W ( x , y )} & 0 & 0 & 0 \\ 0 & \frac{W {\vert}_{{reference}_{brightness} }}{W ( x , y )} & 0 & 0 \\ 0 & 0 & \frac{W {\vert}_{{reference}_{brightness} }}{W ( x , y )} & 0 \\ 0 & 0 & 0 & 1\end{matrix} ] \times [ \begin{matrix}R ( x , y ) \\ G ( x , y ) \\ B ( x , y ) \\ 1\end{matrix} ] \}$$

8. A color compensation system for receiving video frame data by a camera outside a vehicle and automatically compensating for colors of the video frame data for a person with anomalous trichromacy in the vehicle, comprising:
means for extracting digital video frame data input to a digital observation camera;
means for calculating external environment conditions from the extracted video frame data;
means for receiving color blindness characteristics of a color-blind driver;
means for receiving preference of the color-blind driver;
means for compensating for colors of the video frame data according to the external environment conditions and input information; and
means for displaying finally compensated colors according to the preference of the color-blind driver.

9. The color compensation system according to claim 8, wherein the means for calculating the external environment conditions extracts brightness and colors of the external environment from the extracted video frame data and transmits the brightness and colors to a color compensation unit.

10. The color compensation system according to claim 8, wherein the means for receiving the color blindness characteristics receives a type and degree of the color blindness and displays the type of the color blindness, and displays degrees of abnormality of cone cells related to colors using functions p and q as follows:
in the case of Red blindness,
L_{R}^{color blindness}=∫=p(d_{R})L(λ−q(d_{R}))R(λ)dλ
L_{G}^{color blindness}=∫=p(d_{R})L(λ−q(d_{R}))G(λ)dλ
L_{B}^{color blindness}=∫=p(d_{R})L(λ−q(d_{R}))B(λ)dλ
in the case of Green blindness,
M_{R}^{color blindness}=∫=p(d_{G})M(λ−q(d_{G}))R(λ)dλ
M_{G}^{color blindness}=∫=p(d_{G})M(λ−q(d_{G}))G(λ)dλ
M_{B}^{color blindness}=∫=p(d_{G})M(λ−q(d_{G}))B(λ)dλ
in the case of Blue blindness,
S_{R}^{color blindness}=∫=p(d_{B})S(λ−q(d_{B}))R(λ)dλ
S_{G}^{color blindness}=∫=p(d_{B})S(λ−q(d_{B}))G(λ)dλ
S_{B}^{color blindness}=∫=p(d_{B})S(λ−q(d_{B}))B(λ)dλ

11. The color compensation system according to claim 8, wherein the means for receiving the preference of the driver comprises:
means for quantizing a range of colors preferred by the color-blind driver and setting the range to enable the driver to clearly distinguish different colors;
means for magnifying a part of an object desired to be shown in detail by the driver when the driver desires to sense colors of traffic lights or external environment; and
means for reading the colors of the corresponding object, changing the colors to characters, and displaying the characters in a voice form using a TTS technology.

12. The color compensation system according to claim 9, wherein the means for extracting the brightness and colors of the external environment sets a portion of the video frame screen to a reference image piece, and measures the external brightness and colors from the reference image.

13. The color compensation system according to claim 8, wherein the means for compensating for the colors of the video frame data comprises all means for compensating for colors depending on the measured external environment conditions, compensating for colors that is performed by compensating for RGB colors of the extracted video frame data according to a color range of user preference, and compensating for colors depending on the input color blindness characteristics of the driver; and
wherein, in the case of dichromacy, the step of compensating for colors is applied, with a small specific constant numbers other than zero being set instead of an L, M or S value;
wherein the step of compensating for colors is performed using one of the following equations, in the case of Red blindness,
$$[ \begin{matrix}R 4 ( x , y ) \\ G 4 ( x , y ) \\ B 4 ( x , y ) \\ 1\end{matrix} ] = {[ \begin{matrix}{L}_{R}^{color blindness} & {L}_{G}^{color blindness} & {L}_{B}^{color blindness} & 0 \\ {M}_{R} & {M}_{G} & {M}_{B} & 0 \\ {S}_{R} & {S}_{G} & {S}_{B} & 0 \\ 0 & 0 & 0 & 1\end{matrix} ]}^{- 1} \times [ \begin{matrix}{L}_{R} & {L}_{G} & {L}_{B} & 0 \\ {M}_{R} & {M}_{G} & {M}_{B} & 0 \\ {S}_{R} & {S}_{G} & {S}_{B} & 0 \\ 0 & 0 & 0 & 1\end{matrix} ] \times round \{ [ \begin{matrix}\frac{1}{Qstep\_R} & 0 & 0 & 0 \\ 0 & \frac{1}{Qstep\_G} & 0 & 0 \\ 0 & 0 & \frac{1}{Qstep\_B} & 0 \\ 0 & 0 & 0 & 1\end{matrix} ] \times [ \begin{matrix}1 & 0 & 0 & Δ R ( x , y ) \\ 0 & 1 & 0 & Δ G ( x , y ) \\ 0 & 0 & 1 & Δ B ( x , y ) \\ 0 & 0 & 0 & 1\end{matrix} ] \times \\ [ \begin{matrix}\frac{W {\vert}_{{reference}_{brightness} }}{W ( x , y )} & 0 & 0 & 0 \\ 0 & \frac{W {\vert}_{{reference}_{brightness} }}{W ( x , y )} & 0 & 0 \\ 0 & 0 & \frac{W {\vert}_{{reference}_{brightness} }}{W ( x , y )} & 0 \\ 0 & 0 & 0 & 1\end{matrix} ] \times [ \begin{matrix}R ( x , y ) \\ G ( x , y ) \\ B ( x , y ) \\ 1\end{matrix} ] \}$$
in the case of Green blindness,
$$[ \begin{matrix}R 4 ( x , y ) \\ G 4 ( x , y ) \\ B 4 ( x , y ) \\ 1\end{matrix} ] = {[ \begin{matrix}{L}_{R} & {L}_{G} & {L}_{B} & 0 \\ {M}_{R}^{color blindness} & {M}_{G}^{color blindness} & {M}_{B}^{color blindness} & 0 \\ {S}_{R} & {S}_{G} & {S}_{B} & 0 \\ 0 & 0 & 0 & 1\end{matrix} ]}^{- 1} \times [ \begin{matrix}{L}_{R} & {L}_{G} & {L}_{B} & 0 \\ {M}_{R} & {M}_{G} & {M}_{B} & 0 \\ {S}_{R} & {S}_{G} & {S}_{B} & 0 \\ 0 & 0 & 0 & 1\end{matrix} ] \times round \{ [ \begin{matrix}\frac{1}{Qstep\_R} & 0 & 0 & 0 \\ 0 & \frac{1}{Qstep\_G} & 0 & 0 \\ 0 & 0 & \frac{1}{Qstep\_B} & 0 \\ 0 & 0 & 0 & 1\end{matrix} ] \times [ \begin{matrix}1 & 0 & 0 & Δ R ( x , y ) \\ 0 & 1 & 0 & Δ G ( x , y ) \\ 0 & 0 & 1 & Δ B ( x , y ) \\ 0 & 0 & 0 & 1\end{matrix} ] \times \\ [ \begin{matrix}\frac{W {\vert}_{{reference}_{brightness} }}{W ( x , y )} & 0 & 0 & 0 \\ 0 & \frac{W {\vert}_{{reference}_{brightness} }}{W ( x , y )} & 0 & 0 \\ 0 & 0 & \frac{W {\vert}_{{reference}_{brightness} }}{W ( x , y )} & 0 \\ 0 & 0 & 0 & 1\end{matrix} ] \times [ \begin{matrix}R ( x , y ) \\ G ( x , y ) \\ B ( x , y ) \\ 1\end{matrix} ] \}$$
in the case of Blue blindness,
$$[ \begin{matrix}R 4 ( x , y ) \\ G 4 ( x , y ) \\ B 4 ( x , y ) \\ 1\end{matrix} ] = {[ \begin{matrix}{L}_{R} & {L}_{G} & {L}_{B} & 0 \\ {M}_{R} & {M}_{G} & {M}_{B} & 0 \\ {S}_{R}^{color blindness} & {S}_{G}^{color blindness} & {S}_{B}^{color blindness} & 0 \\ 0 & 0 & 0 & 1\end{matrix} ]}^{- 1} \times [ \begin{matrix}{L}_{R} & {L}_{G} & {L}_{B} & 0 \\ {M}_{R} & {M}_{G} & {M}_{B} & 0 \\ {S}_{R} & {S}_{G} & {S}_{B} & 0 \\ 0 & 0 & 0 & 1\end{matrix} ] \times round \{ [ \begin{matrix}\frac{1}{Qstep\_R} & 0 & 0 & 0 \\ 0 & \frac{1}{Qstep\_G} & 0 & 0 \\ 0 & 0 & \frac{1}{Qstep\_B} & 0 \\ 0 & 0 & 0 & 1\end{matrix} ] \times [ \begin{matrix}1 & 0 & 0 & Δ R ( x , y ) \\ 0 & 1 & 0 & Δ G ( x , y ) \\ 0 & 0 & 1 & Δ B ( x , y ) \\ 0 & 0 & 0 & 1\end{matrix} ] \times \\ [ \begin{matrix}\frac{W {\vert}_{{reference}_{brightness} }}{W ( x , y )} & 0 & 0 & 0 \\ 0 & \frac{W {\vert}_{{reference}_{brightness} }}{W ( x , y )} & 0 & 0 \\ 0 & 0 & \frac{W {\vert}_{{reference}_{brightness} }}{W ( x , y )} & 0 \\ 0 & 0 & 0 & 1\end{matrix} ] \times [ \begin{matrix}R ( x , y ) \\ G ( x , y ) \\ B ( x , y ) \\ 1\end{matrix} ] \}$$

14. A color observation system for vehicles connected to an external camera, comprising:
means for compensating for colors of video frame data input from an observation camera in view of external brightness and colors;
means for compensating for colors in view of color blindness characteristics of a color-blind driver;
means for compensating for colors according to preference of the color-blind driver; and
means for receiving color information of external objects through a monitor or speaker according to user preference.
